(19) United States
(12) Patent Application Publication
(10) Pub. No.: US 2013/0227810 A1
(43) Pub. Date: Sep. 5, 2013

(54) HINGED WIPER BLADE

(71) Applicant: PYLON MANUFACTURING CORP., Deerfield Beach, FL (US)

(72) Inventors: Vambi Raymundo Tolentino, Coconut Creek, FL (US); Robert Peter Peers, Boca Raton, FL (US); George Chang, Taipei (TW); Sandro Lo, Taipei (TW)

(73) Assignee: Pylon Manufacturing Corp., Deerfield Beach, FL (US)

(21) Appl. No.: 13/776,383

(22) Filed: Feb. 25, 2013

Related U.S. Application Data
(60) Provisional application No. 61/603,223, filed on Feb. 24, 2012.

(51) Int. Cl. B60S 1/40

(52) U.S. Cl. CPC B60S 1/4003
USPC 15/250.32

(57) ABSTRACT

A wiper blade having a wiper strip, a primary frame and a pair of secondary frames. The primary frame may have a top side and opposite ends, a connection device capable of connecting the wiper blade to a wiper arm disposed on the top side of the primary frame, and a connection structure disposed on each of the opposite ends of the primary frame. Each secondary frame may have a central pivot connection portion and two leg portions extending from the central pivot connection portion, a pivot structure disposed on the central pivot connection portion of the secondary frames. The pivot structure may be a turn-buckle holder comprising two holder halves and a rivet wherein the rivet passes through the two holder halves and holds them together.

### CROSS REFERENCE TO RELATED APPLICATIONS

This application claims the benefit of U.S. Provisional Application No. 61/603,223 filed Feb. 24, 2012, the disclosure of which is hereby incorporated herein by reference in its entirety.

### FIELD OF THE INVENTION

This invention relates to the field of windshield wiper blades.

### BACKGROUND

Typical wiper blades used on vehicles are plagued with numerous persistent drawbacks. In an effort to improve upon the traditional, bracketed wiper blade, the beam blade (or flat blade) was developed, keeping a lower profile and generally providing a more uniform force distribution than most bracketed wiper blades. However beam blades do not have the lateral stability of bracketed blades, and can have problems with wrapping (i.e. keeping contact between the outer edges of the wiper blade and the windshield) when their curvature is not sufficiently sharp for the windshield, and banding (i.e. losing contact with the windshield in the middle of the wiper blade, thereby leaving an unwiped band) when their curvature is too sharp for the windshield. Accordingly, beam blades may serve well for original equipment (i.e. the wiper blades installed by manufacturers on cars that are designed specifically for that car, but can experience problems on certain vehicles if designed as aftermarket wiper blades (i.e. replacement blades designed to be used on a variety of different windshields where the manufacturer does not know what vehicle the blade will be used on).

The first generation of hybrid wiper blades developed improved on beam blade performance in these circumstances. These blades combine the use of brackets with a beam to improve on the blades' wrapping characteristics without creating problems with banding. The disclosed concept provides an improvement on the first generation hybrid wiper blades, using a combination of traditional brackets and either beams or flat brackets.

The following patent applications are hereby incorporated by reference in their entirety, including their disclosures with respect to the background and field of art of wiper blades: U.S. patent application Ser. Nos. 13/453,601; 13/679,646; 13/572,100 and 13/587,389.

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one embodiment a wiper blade has a wiper strip, a primary frame and a pair of secondary frames. The primary frame may have a top side and opposite ends, a connection device capable of connecting the wiper blade to a wiper arm disposed on the top side of the primary frame, and a connection structure disposed on each of the opposite ends of the primary frame. Each secondary frame may have a central pivot connection portion and two leg portions extending from the central pivot connection portion, a pivot structure disposed on the central pivot connection portion of the secondary frames. The pivot structure may be a turn-buckle holder comprising two holder halves and a rivet wherein the rivet passes through the two holder halves and holds them together.

In another embodiment, a hinge for a wiper blade capable of connecting a parent frame to a child frame is made up of a turn-buckle holder comprising two holder halves and a rivet, wherein the rivet passes through the two holder halves and holds them together.

### BRIEF DESCRIPTION OF THE FIGURES

FIG. 1 illustrates a perspective view from above of an embodiment of the invention.

FIG. 2 illustrates a frontal view of an embodiment of the invention.

FIG. 3 illustrates a perspective view from above of the primary frame of an embodiment of the invention.

FIG. 4 illustrates a perspective view from above of an alternative embodiment of the primary frame.

FIG. 5 illustrates a view of the primary frame of an embodiment of the invention along the longitudinal axis of the wiper blade.

FIG. 6a illustrates a side view of a beam of an embodiment of the invention, wherein the beam is shown flattened for simplicity.

FIG. 6b illustrates a side view of a beam of an embodiment of the invention, wherein the beam is shown in it curved state.

FIG. 7 illustrates a perspective view from above of a beam of an embodiment of the invention, wherein the beam is shown flattened for simplicity.

FIG. 8 illustrates a rivet which may be used in the joint of an embodiment of the invention.

FIG. 9 illustrates a perspective view from the side of a turn-buckle holder used in a joint of an embodiment of the invention.

FIG. 10 illustrates a view of a turn-buckle holder used in a joint of an embodiment of the invention along the axis of the channel.

FIG. 11 shows a bottom view of a turn-buckle holder used in a joint of an embodiment of the invention.

FIG. 12 shows a cross-sectional view of a turn-buckle holder used in a joint of an embodiment of the invention through the turn-buckle holder's channel.

FIG. 13 illustrates a perspective view from the side of a holder half used in a joint in an embodiment of the invention.

FIG. 14 illustrates a view of a holder half used in a joint in an embodiment of the invention along the axis of the channel.

FIG. 15 illustrates a view of a holder half used in a joint in an embodiment of the invention along the axis of the rivet passage.

FIG. 16 illustrates a bottom view of the holder half used in a joint in an embodiment of the invention.

FIG. 17 illustrates a frontal view of a symmetric tertiary bracket of an embodiment of the invention.

FIG. 18 illustrates a perspective view from above of a symmetric tertiary bracket of an embodiment of the invention.

FIG. 19 illustrates a frontal view of an asymmetric tertiary bracket of an embodiment of the invention.

FIG. 20 illustrates a perspective view from above of an asymmetric tertiary bracket of an embodiment of the invention.

FIG. 21 illustrates a perspective view of the pivoting stud of an embodiment of the invention.

### DETAILED DESCRIPTION

The following detailed description and the appended drawings describe and illustrate exemplary embodiments of the invention solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

This patent application sets forth a novel hybrid (i.e. having both a spring elastic “beam” and one or more brackets/frames) wiper blade. Several novel concepts are introduced which can be used both with the disclosed novel wiper blade, or separately with various kinds of traditional, hybrid or beam wiper blades. These novel concepts include, but are not limited to, a novel hinge between frames of a wiper blade that is designed for hybrid wiper blades but can also be used in bracketed blades, which allows a generally thin, flat beam or beam-like frame a greater range of motion without interfering with its elasticity, and which allows the blade to keep a low wind profile.

In one embodiment, a wiper blade may include a wiper strip, a primary frame and a pair of secondary frames. The primary frame may have a top side and opposite ends, a connection device capable of connecting the wiper blade to a wiper arm disposed on the top side of the primary frame, and a connection structure disposed on each of the opposite ends of the primary frame. The pair of secondary frame may each have a central pivot connection portion, two leg portions extending from the central pivot connection portion, and a pivot structure disposed on the central pivot connection portion of the secondary frames. The pivot structure may be a turn-buckle holder comprising two holder halves and a rivet wherein the rivet passes through the two holder halves and holds them together.

In certain embodiments, the holder halves may further comprise a channel that receives the central pivot connection portion of the respective secondary frame. In such embodiments, the central pivot connection portion of the secondary frames may be provided with recesses and the holder halves are provided with projections which fit into the recesses in the central pivot connection portion of the secondary frames. In certain embodiments, the connection structure on the ends of the primary frame comprises pivot extension walls.

In certain embodiments, the secondary frame may have a generally thin structure. In certain of these embodiments, the secondary frame may be a beam. In certain other embodiments, the secondary frame may be a bracket.

In certain embodiments, the legs of the secondary frames may be symmetrical. In other embodiments, one of the two leg portions of a first beam of the pair of beams may be longer than the other leg portion of the first beam of the pair of beams. In certain embodiments, at least one leg portion of at least one of the secondary frames may be provided with a wiper strip holder capable of securing the wiper strip. In other embodiments wherein a pair of tertiary frames may connect to each of the secondary frames, and the tertiary frames secure the wiper strip.

In certain embodiments at least one tertiary frame, wherein at least one leg portion of at least one of the secondary frames may be provided with a tertiary frame connection structure, and wherein the at least one tertiary frame is connected to the tertiary frame connection structure of the least one of the secondary frames. In certain such embodiments, the tertiary frame may be symmetric. In other such embodiments, the tertiary frame has two legs descending from a middle portion and one of the two legs is longer than the other.

In certain embodiments, a hinge for a wiper blade capable of connecting a parent frame to a child frame may include a turn-buckle holder comprising two holder halves and a rivet, wherein the rivet passes through the two holder halves and holds them together.

In certain embodiments, a wiper blade may include a wiper strip, a primary frame and a pair of secondary frames. The primary frame, may have a top side and opposite ends, a connection device capable of connecting the wiper blade to a wiper arm disposed on the top side of the primary frame, and a connection structure disposed on each of the opposite ends of the primary frame. The pair of pair of secondary frames, may each have a central pivot connection portion, two leg portions extending from the central pivot connection portion, and a pivot structure disposed on the central pivot connection portion of the secondary frames. The pivot may be a turn-buckle holder comprising a unitary structure.

In certain embodiments the central pivot connection portion of the secondary frames is provided with recesses and the turn-buckle holder is provided with projections which fit into the recesses in the central pivot connection portion of the secondary frames. In certain embodiments, the connection structure on the ends of the primary frame comprises pivot extension walls. In certain embodiments, the secondary frame has a generally thin structure. In certain embodiments, a pair of tertiary frames may connect to each of the secondary frames, and the tertiary frames secure the wiper strip.

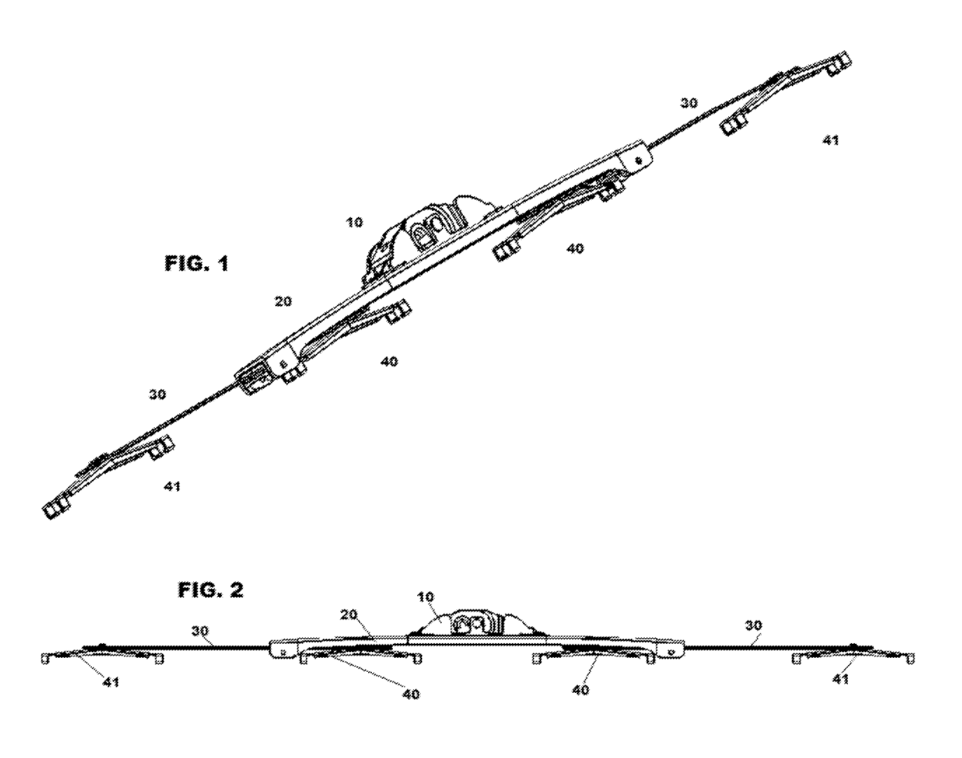

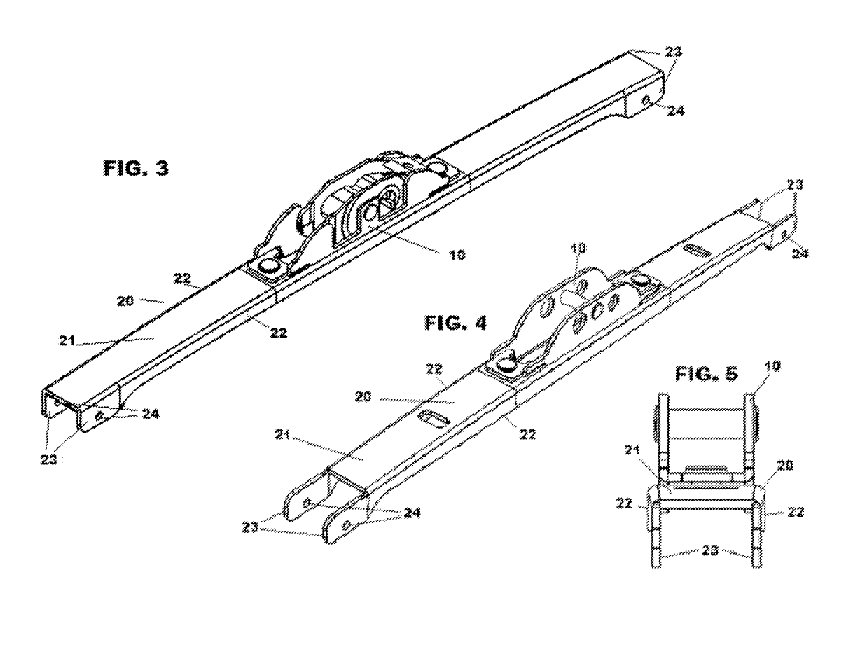

As can be seen in FIGS. 1-4 the main support structure of the wiper blade preferably includes a primary frame 20 having a connection device 10 on its top side to which a connector and/or or adapter (not shown) can be used to connect the wiper blade to a wiper arm. FIG. 3 shows a connection device 10 with a connector attached. FIG. 4 shows an alternative connection device having a central rivet for connecting a connector, but where a connector is not attached. Suitable connectors which allow the wiper blade to be connected to various different types of wiper arms are known in the art, and include U.S. Pat. No. 6,640,380 and U.S. patent application Ser. Nos. 13/558,624, 13/560,585, and 13/194,070 each of which is incorporated by reference herein in its entirety. Alternatively, the connection device 10 can be implemented to connect directly to a particular kind of wiper arm with or without the use of a connector and/or adapter. Persons of skill in the art will recognize that there are numerous types of connection devices 10 known in the art, and that the invention can be practiced with any of them. The connection device 10 may attach to the primary frame 20 through the use of welding, screws, rivets, claws, crimping or any other method known in the art. Alternatively, the connection device 10 may be an integrated part of the structure of the primary frame 20. The connection device 10 may be made out of metal, plastic or any other suitable material known in the art or any combination of suitable materials known in the art.

The primary frame 20 may be made out of metal, plastic or any other suitable material known in the art, or any combination of suitable materials known in the art. The primary frame 20 may be straight or predominantly straight in shape when viewed from the front (as shown in FIG. 2-4), or may bear a more pronounced curvature. A connection to a pivot structure may be located at each end of the primary frame 20, and allows the primary frame 20 to connect to a secondary frame or beam 30, in such a manner as to allow the beam 30 to pivot about a pivot axis. A novel pivot structure is described below, but numerous variations on this structure may be used in connection with the described wiper blade within the scope of the invention.

As shown in FIG. 5, the profile of the primary frame 20 below the connection device 10, when viewed along the longitudinal axis of the wiper blade, is preferably U shaped to add strength and rigidity to the primary frame. The primary frame may have a horizontal wall 21 from which two side walls 22 may descend vertically. The distance between the side walls 22 may be constant along the length of the primary frame 20, or it may taper or expand as it approaches either end of the primary frame 20. As described above, at either end of the primary frame is a connection to a pivot structure. One such connection is shown in FIGS. 2-5, as pivot extension walls 23. These pivot extension walls 23 extend from the side walls 22 of the primary frame 20 and facilitate the connection of the primary frame 20 to the pivot structure. The pivot extension walls may be provided with holes 24 which will form part of the pivot structure, wherein a rivet, or protrusions may be placed to facilitate the pivoting of the beams 30. Persons of skill in the art will recognize that various alternative pivot structures or variations on the described pivot structure might be used and remain within the scope of the invention, including without limitation providing the pivot extension walls with protrusions instead of holes, or a rivet onto which other parts of the pivot structure can attach by in any known manner, providing the turn-buckle holders, or holder halves 52 described below with projections that can enter into the holes 24 of the pivot extension walls 23, etc.. The horizontal wall 21 may end before, or part way along, the pivot extension walls 23 (as shown in FIG. 4) in order to give the pivot structure a wider range of motion, or may optionally extend all the way to the end of, or past, the pivot extension walls 23 (as shown in FIG. 3).

As discussed in greater detail in U.S. Provisional Application No. 61/603,222 and the non-provisional application filed concurrently herewith entitled “Wiper Blade” filed concurrently herewith, the primary frame 20 and/or the connection device 10 may also have cover-connection structures, such as projections, recesses, extension walls with holes, recesses, projections or rivets, etc., to facilitate the connection of the cover 60, 70, or portions thereof, to the primary frame 20.

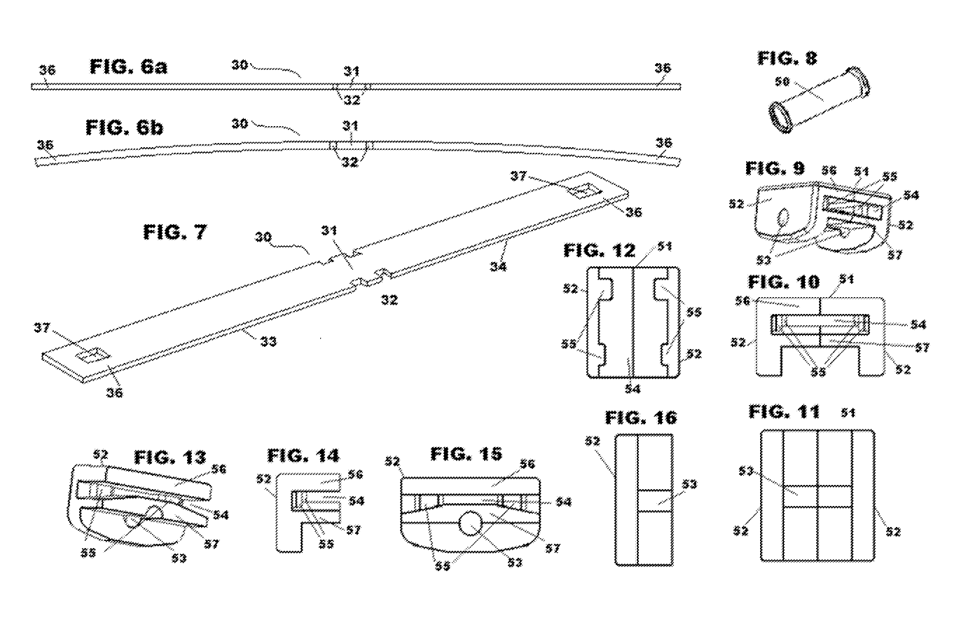

The beam 30 is preferably made out of spring-elastic steel, but any suitable material known in the art may be used. In certain embodiments (not shown in the figures), the beam 30. The beam is preferably curved, as shown in FIG. 6b, but is depicted flattened in FIGS. 1, 2, 6a and 7 for illustrative purposes. can be a curved, spring-elastic beam, making the such embodiments “hybrid” wiper blades, as they are a hybrid combining elements of a bracketed (or framed) wiper blade and a beam (or frameless) wiper blade. The beam 30 preferably has a central pivot connection portion 31, which connects the beam 30 to the primary frame 20 via a pivot structure. The central pivot connection portion 31 is may be flattened or curved. The central pivot connection portion 31 may have connecting structures, such as recesses 32; projections; or pivot joint wings having either (1) a rivet or projections to attach to corresponding recesses, holes or clips in the primary frame's 20 pivot extension walls 23 or other connection to a pivot structure; or (2) recesses to receive corresponding projections, rivets, etc. in the primary frame's 20 pivot extension walls 23 or other connection to a pivot structure. Persons of skill in the art will recognize that numerous types of pivot structures can be used, whether directly connecting the beam 30 to the primary frame 20, or as described below in the novel pivot joint presented, using an intermediary piece (or pieces) to join the two.

On either side of the central pivot connection portion 31, the beam 30 has legs 33, 34. The legs 33, 34 of the beam 30 may be symmetric (as shown in FIGS. 6a, 6b and 7) or asymmetric. The legs 33, 34 of the beam 30 may be of the same, or different in lengths. In some embodiments, it may be advantageous to have the outer leg 33 (the leg further from the middle of the wiper blade) with a longer length than the inner leg 34 to allow a more compact primary frame 20, while still allowing the wiper blade to wrap around the curvature of the windshield along its extremities, and improve wipe quality. Similarly, each leg 33, 34 may be independently curved. In some embodiments it may be advantageous to have the curvature of the inner leg 34 (i.e. the leg closer to the center of the wiper blade) be different than the curvature of the outer leg 33. In some embodiments, it can be particularly advantageous to provide the inner leg 34 with a sharper curvature than the curvature of the outer leg 33 in order to provide better wrapping of the wiper blade around the curvature of a windshield, and thus improving wipe quality.

A novel method of connecting the primary frame to the beam 30 to the primary frame 20 uses a turn-buckle holder 51 made up of two holder halves 52 held together by a rivet 50. Thus, when assembled, one holder half 52 is attached to the beam 30 opposite the other holder half 52 at the central pivot connection portion 31 wherein the central pivot connection portion 31 is inserted into the channel 54 formed between the upper channel wall 56 and lower channel wall 57 of each holder half 52. The holder halves 52 are then pushed together such that the holder half's 52 projections 55 engage the recesses 32 on the central pivot connection portion 31 of the beam 30. Alternatively, in embodiments where the central pivot connection portion 31 has projections, the holder halves 52 can be implemented so as to have recesses to receive such projections. Alternatively, in place of a rivet, the pivot extension walls 23 may have projections to act as a rivet, or may have recesses or holes to receive projections on the outer walls of the holder halves 52. As discussed above, persons of skill in the art will recognize that numerous variations to the pivoting structure joining the primary frame 20 and the beam 30 that has been presented may be made within the scope of the invention.

Once the holder halves 52 have been pushed together such that the turn-buckle holder 51 contains the beam 30 within its channel 54, the turn-buckle holder can be placed between the pivot extension walls 23 of the primary frame 20, and a rivet 50 (shown in FIG. 8) can be passed through the holes 24 in the pivot extension walls 23 and through the rivet passage 53 in the turn-buckle holder 51 and secured on the opposite side. Persons of skill in the art will recognize that various modifications of such a structure can be made while remaining within the scope of the invention, including without limitation, providing protrusions on the pivot extension walls 23 which can engage the rivet passage 53 in the turn-buckle holder, or providing the turn-buckle holder 51 with protrusions that can engage the holes 24 in the pivot extension walls 23. FIGS. 9-12 show various views of the turn-buckle holder 51. FIG. 12, in particular, shows a cross-section of the turn-buckle holder 51 taken through the channel 54 along its plane. As can be seen in FIG. 12, the projections inside the holder halves 52 (and thus also the corresponding recesses 32 in the beam 30) can be made of varying sizes, and need not be symmetric with the projections 55 in the opposite holder half 52. In certain embodiments, such as that depicted in FIG. 12, two different sizes of projections 55 may be used in the holder halves 52 in order to facilitate proper alignment of the beam 30 with the turn-buckle holder 51 during assembly. In an alternative embodiment, the turn-buckle holder 51 is a unitary structure. Such a structure can be made through insert molding, where the unitary turn-buckle holder is molded around the secondary frame. This provides a tighter grip by the turn-buckle holder on the secondary frame.

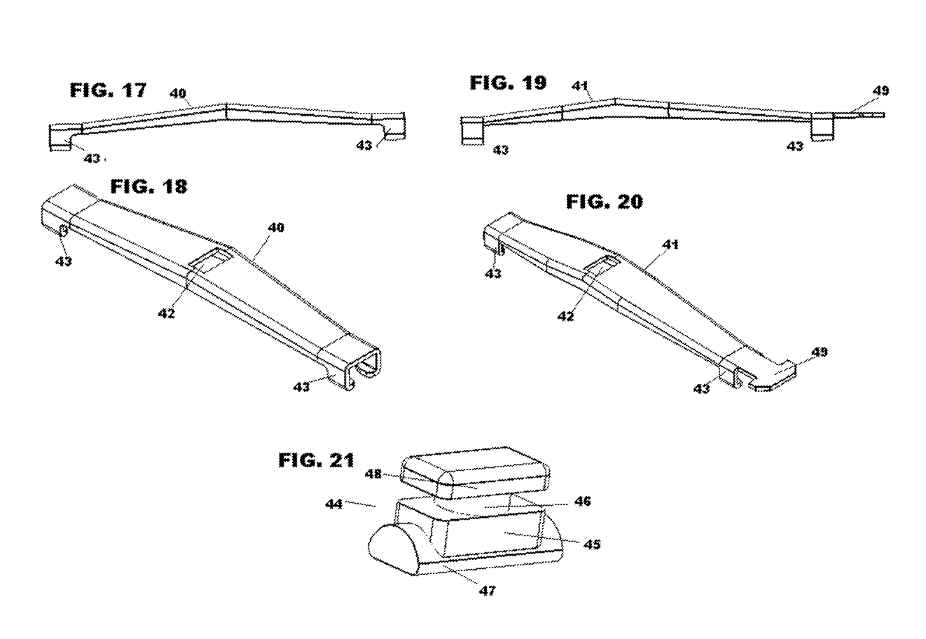

FIGS. 13-16 show various views of a holder half 52. As can best be seen in FIGS. 13 and 15, the lower channel wall 57 may be angled, or curved in order to allow pivoting of the beam 30 within the turn-buckle holder 51, or to facilitate the attachment of the turn-buckle holder to the secondary frame 30 by providing a wider entry point on the edges of the channel 54 in the holder half 52 while still providing a snug-fitting attachment in the middle portion of the holder half 52. Alternatively, both the top channel wall 56 and the lower channel wall 57 may be shaped to follow the contour of the central pivot connection portion 31 of the beam 30 or to facilitate insertion of the beam 30 into the holder halves 52. This novel pivot-hinge connection between the primary and secondary frames can be accomplished within the limited height of the pivot extension walls 23 of the primary frame 20, and thus allows the disclosed wiper blade to maintain a relatively low profile, thereby reducing the effect of wind-lift on the wiper blade at high speeds and reducing or obviating the need for a spoiler on the wiper blade.

The ends of the beam 30 may either be provided with a wiper blade holder, such as the claws 43 on the tertiary frames 40, 41, or may with a connection extension 36 having a structure to connect to a tertiary frame 40, 41. In certain embodiments, as shown in FIGS. 6-7 and 17-21 the connection between the beam 30 and the tertiary frame(s) 41, 42 is formed by passing a pivoting stud 44 through a hole 42 in the central joint connection portion of the tertiary frame and a hole 37 in the connection extensions 36 on the beam 30. As shown in FIG. 21, the pivoting stud 44 has a tertiary base portion 45 sized to fit in the hole 42 of the tertiary frame 40, 41, and a bottom portion 47 that is wider than the hole 42 in the tertiary frame 40, 41. Thus tertiary frame 40, 41, is supported on the bottom portion 47 of the pivoting stud 44 when the wiper blade is assembled. Accordingly the base portion 47 may be curved (as shown in FIG. 21) or angled in order to facilitate the pivoting of the tertiary frame 40, 41. The pivoting stud 44 is also provided with a top portion 48 and a neck 46 wherein the diameter of the neck is approximately the same as the width of top portion 48 and smaller than the length of the top portion. Both are the top portion and the neck are sized to fit into the hole 37 of the secondary frame, and the height of the neck is approximately the same as the thickness of the connection extension 36 of the secondary frame 30. During assembly, the pivoting stud's 44 top portion 48 and neck 46 are inserted into hole 37 in the connection extension 36 of the beam 30, and then turned such that the top portion 48 is perpendicular to the long side of the hole 37 in the connection extension 36. Accordingly a high friction material, such as natural or synthetic rubber is preferred for the pivoting stud 44, but plastic and/or other suitable materials may also be used. Persons of skill in the art will recognize that alternative forms of connecting the tertiary frames to the secondary frames may be used within the scope of the invention, and that any of the forms for creating a pivoting structure/joint between the primary and secondary frames discussed above could be implemented between the secondary and tertiary frames, and vice versa.

The tertiary frames 40, 41 may be symmetrical tertiary frames 40 or asymmetrical tertiary frames 41. In certain embodiments it may be advantageous to use symmetrical tertiary frames 40 on the connection extensions 36 nearer to the middle of the wiper blade, and asymmetric tertiary frames 41 on the connection extensions 36 nearer to the extremities of the wiper blade. In such embodiments it may be advantageous to put the longer leg of the asymmetric tertiary frames 41 extending outward from the wiper blade so as to provide a better wrap around the surface of a curved windshield of a vehicle.

Whether symmetric or asymmetric, the tertiary frames are provided with claws 43 which support the wiper strip 15. The wiper blade described herein can use any of the traditional wiper strips known in the art, which generally have a base portion having grooves into which metal vertebrae are inserted to provide lateral support for the wiper strip 15. Alternatively, the wiper blade described above can be implemented using the wiper strip carrier described in U.S. patent application Ser. No. 13/679,646, which is incorporated herein by reference in its entirety, and is attached hereto.

The primary frame, tertiary frame, and/or beam may be provided with cover securing devices which can assist in the securing of a cover or spoiler onto the wiper blade. Alternatively, a cover or a spoiler can be structured so as to grip, or otherwise be secured to the frames and beams 30 of the invention. Some covers which may be used with the invention are described in the U.S. Provisional Application 61/603,222 and in the related nonprovisional application filed concurrently herewith entitled “Wiper Blade” filed concurrently herewith. Any such cover or spoiler known in the art may be used with the invention, and can be secured to the invention in any way known in the art.

The descriptions set forth above are meant to be illustrative and not limiting, and persons of skill in the art will recognize that various common and known deviations from the above described structures are considered to be within the scope of the invention(s) described herein.

We claim:

1. A wiper blade comprising:
a wiper strip,
a primary frame, having a top side and opposite ends, a connection device capable of connecting the wiper blade to a wiper arm disposed on the top side of the primary frame, and a connection structure disposed on each of the opposite ends of the primary frame;
a pair of secondary frame, each having a central pivot connection portion and two leg portions extending from the central pivot connection portion, a pivot structure disposed on the central pivot connection portion of the secondary frames;
wherein the pivot structure comprises is a turn-buckle holder comprising two holder halves and a rivet wherein the rivet passes through the two holder halves and holds them together.

2. The wiper blade for claim 1 wherein the holder halves further comprise a channel that receives the central pivot connection portion of the respective secondary frame.

3. The wiper blade of claim 2 wherein the central pivot connection portion of the secondary frames is provided with recesses and the holder halves are provided with projections which fit into the recesses in the central pivot connection portion of the secondary frames.

4. The wiper blade of claim 1 wherein the connection structure on the ends of the primary frame comprises pivot extension walls.

5. The wiper blade of claim 1 wherein the secondary frame has a generally thin structure.

6. The wiper blade of claim 5 wherein the secondary frame is a beam.

7. The wiper blade of claim 5 wherein the secondary frame is a bracket.

8. The wiper blade of claim 1 wherein the legs of the secondary frames are symmetrical

9. The wiper blade of claim 1 wherein one of the two leg portions of a first beam of the pair of beams is longer than the other leg portion of the first beam of the pair of beams.

10. The wiper blade of claim 1 wherein at least one leg portion of at least one of the secondary frames is provided with a wiper strip holder capable of securing the wiper strip.

11. The wiper blade of claim 1 wherein a pair of tertiary frames connect to each of the secondary frames, and the tertiary frames secure the wiper strip.

12. The wiper blade of claim 1 further comprising at least one tertiary frame, wherein at least one leg portion of at least one of the secondary frames is provided with a tertiary frame connection structure, and wherein the at least one tertiary frame is connected to the tertiary frame connection structure of the least one of the secondary frames.

13. The wiper blade of claim 12 wherein the tertiary frame is symmetric.

14. The wiper blade of claim 12 wherein the tertiary frame has two legs descending from a middle portion and one of the two legs is longer than the other.

15. A hinge for a wiper blade capable of connecting a parent frame to a child frame comprising:
a turn-buckle holder comprising two holder halves and a rivet, wherein the rivet passes through the two holder halves and holds them together.

16. A wiper blade comprising:
a wiper strip,
a primary frame, having a top side and opposite ends, a connection device capable of connecting the wiper blade to a wiper arm disposed on the top side of the primary frame, and a connection structure disposed on each of the opposite ends of the primary frame;
a pair of secondary frame, each having a central pivot connection portion and two leg portions extending from the central pivot connection portion, a pivot structure disposed on the central pivot connection portion of the secondary frames;
wherein the pivot structure comprises a turn-buckle holder comprising a unitary structure.

17. The wiper blade of claim 16 wherein the central pivot connection portion of the secondary frames is provided with recesses and the turn-buckle holder is provided with projections which fit into the recesses in the central pivot connection portion of the secondary frames.

18. The wiper blade of claim 16 wherein the connection structure on the ends of the primary frame comprises pivot extension walls.

19. The wiper blade of claim 16 wherein the secondary frame has a generally thin structure.

20. The wiper blade of claim 1 wherein a pair of tertiary frames connect to each of the secondary frames, and the tertiary frames secure the wiper strip.
